(19) United States
(12) Patent Application Publication
(10) Pub. No.: US 2011/0100926 A1
(43) Pub. Date: May 5, 2011

(54) FILTRATION SYSTEM FORCING WATER IN EITHER DIRECTION

(76) Inventors: Andrew Moore, Victoria (AU); Steve Watt, Victoria (AU)

(21) Appl. No.: 12/673,481

(22) PCT Filed: Aug. 14, 2008
(86) PCT No.: PCT/GB2008/002755

§ 371 Date: Dec. 8, 2010

(30) Foreign Application Priority Data
Aug. 15, 2007 (GB) 0715945.2

(51) Int. Cl. B01D 37/04; B01D 35/14; C02F 1/00

(52) U.S. Cl. 210/741; 210/108; 210/104; 210/85

(57) ABSTRACT

A filtration system is provided that may be used in remote areas; a pump for forcing water through a filter is powered by at least one solar panel and may force water through the filter in either direction; in a filtering operation, water is passed in a forward direction until a pressure sensor measures that the water pressure on the filtered water side of the filter has dropped to a predetermined level, at which point water is forced through the filter in the reverse direction. A controller is configured to control the operation of the pump.

The present invention relates to the provision of potable water in remote areas. In particular, the present invention relates to the provision of a filtration system that enables water purification in such areas.

A problem in remote areas, especially in developing countries, is that there is no infrastructure provided to supply clean water. Contaminants such as micro-organisms which may cause disease, may be present in available water due to the source being contaminated by human or animal waste. If would therefore be desirable to provide a system that enables the purification of the water in order to reduce the illness and death caused by waterborne diseases. However, any such system must be appropriate for use in the environment of such remote areas.

Accordingly, it is an object of the present invention to provide an improved system for use in preparing potable water in remote areas.

According to the present invention there is provided a water filtration system, comprising:
a filter;
a pump for forcing water through the filter; and
at least one solar panel, configured to power the pump;
wherein the pump is configured such that it may force water through the filter in either a forward direction in order to pass water from an unfiltered water side to a filtered water side or in a reverse direction in order to pass water from a filtered water side to an unfiltered water side; and
the water filtration system further comprises:
a pressure sensor, configured to measure the water pressure on the filtered water side of the filter; and
a controller, configured to control the operation of the pump such that, in filtering operation, water is forced through the filter in the forward direction and, when the water pressure on the filtered water side of the filter drops below a predetermined level, water is forced through the filter in the reverse direction.

The present invention also provides a water filtration method, comprising:
forcing water through a filter using a pump in a forward direction in order to pass water from an unfiltered water side to a filtered water side;
powering the pump using at least one solar panel;
measuring the water pressure on the filtered water side of the filter using a pressure sensor; and
controlling the operation of the pump such that, when the water pressure on the filtered water side of the filter drops below a predetermined level, water is forced through the filter in a reverse direction from a filtered water side to an unfiltered water side.

Such a system is especially appropriate for use in remote areas because it is powered by a solar panel and thus may be used in areas in which power is not provided.

Furthermore, the operation of the system is not dependent on the operation of, for example, a generator, improving the reliability of the system and avoiding the expense for the users of the system of providing fuel to run such a generator. Furthermore, the reliability of the system is improved by the provision of a controller that controls the system such that water is forced through the filter in the reverse direction because such an operation may be used to remove particles that are blocking the pores of the filter. Accordingly, less maintenance of the system is required. Furthermore, the provision of a pressure sensor that is used to trigger such a back-pulse of water through the filter when the water pressure on the filtered water side of the filter drops below a given level, due to the pores of the filter becoming blocked, simplifies operation of the system for the user. In addition the reliability of the system is improved because it is not dependent upon, for example, the user periodically triggering the back-pulse of water through the filter.

Preferably, the system also includes an air blower that supplies air to the system such that it bubbles through the filter during a back-pulse of water through the filter. The air bubbles provide agitation which helps remove the particles from the pores of the filter.

Preferably, the system includes a battery that provides the power for the air blower and is recharged by power from the at least one solar panel. Such an arrangement is beneficial because there may not be sufficient power provided by the solar panels at a given instant to power both the pump and the air blower.

Preferably, the pump is a positive displacement pump and in particular may be a helical rotor pump with a rotating metal rotor in a rubber stator. An advantage of such a pump is that the pressure generated by the pump is largely independent of the pump speed. In a solar powered system such as the present invention, the pump speed will vary with the amount of sunlight. By using a positive displacement pump, even if there is limited sunlight, the system will still provide enough pressure to produce filtered water, albeit that the flow rate will be dependent on the amount of sunlight. Furthermore, because the pressure generated by the pump is largely independent of the flow rate, the pressure measured by the pressure sensor is dependent on the flow rate determined by the friction through the filter and a single pressure level for triggering the back-pulse of water through the filter may be used, regardless of the speed of the pump, namely regardless of the amount of sunlight. Finally, a further advantage of the use of a positive displacement pump is that it may operate in either direction. Accordingly, simply by changing the direction in which the pump is driven, it is possible to change the direction in which the water is driven. Therefore, the back-pulse of water through the filter may be provided without the requirement of a complicated arrangement of valves.

Preferably, the pump is driven by a motor that is directly powered by the at least one solar panel and is arranged such that the motor may be driven in either a forward direction or a reverse direction under the control of the controller. Accordingly, the motor may be directly connected to the pump without the requirement for a complicated linkage and the controller may control the direction of flow of the water simply by the control of the direction of the motor. By simplifying the construction of the system in this manner, the reliability of the system may be improved.

The filter is preferably arranged such that it can remove substantially all particles from the water that may harbour disease. For example, the filter may be arranged such that only particles smaller than 1×10⁻⁷ m in size are passed through the filter. Accordingly, for example micro-organisms that may cause disease, including for example, bacteria, parasites, fungi and at least some viruses may be removed from the water.

Preferably, the pump is provided on the filtered water side of the filter and the pressure sensor is arranged to measure the pressure between the filter and the pump, namely is also on the filtered water side of the filter. Accordingly, both the pump and the pressure sensor are only in contact with the filtered water, reducing the likelihood of any damage or reduction in the lifetime of the pump or pressure sensor caused by contact with unfiltered water.

The solar panels may comprise one or more photovoltaic cells. Preferably, therefore, the controller includes a maximum power point tracking unit that may optimise the loading of the photovoltaic cells in order to maximise the power extracted from the photovoltaic cells. Such a unit may increase the efficiency of the system and optimise the amount of water that may be filtered for a given level of sunlight.

The system preferably includes a discharge water tank into which the filtered water may be passed for storage prior to use. Accordingly, the users of the filtration system may obtain their water from the discharge water tank rather than from the filtration system. This is beneficial because the filtration system will only operate if there is sufficient sunlight and will not operate at night. Accordingly, by storing the water in a discharge tank, water may be available at all times rather than only when there is sufficient sunlight.

Preferably, a back-pulse water storage tank is also provided and arranged to initially fill in preference to the discharge water tank. Accordingly, once the back-pulse water storage tank is filled to a given level, subsequently filtered water is passed to the discharge water tank. Accordingly, a supply of water for back-pulses used to clear the filter may remain available even when there is high demand for water that may result in the discharge water tank becoming empty.

The back-pulse of water through the filter, namely the flow of water in the reverse direction through the filter should be maintained sufficiently long to clear the pores of the filter. Therefore, the back-pulse may continue until the water in the back-pulse tank has fallen to a second predetermined level. This may be set such that the amount of water that is passed in the reverse direction through the filter during the back-pulse is sufficient to clear the filter as required. Alternatively or additionally, the controller may be configured to stop the back-pulse after a given period of time. Alternatively or additionally, the termination of the back-pulse by the controller may be in response to measurements made by the pressure sensor. For example it is expected that, when the back-pulse is initiated, the pressure will increase to a maximum but the pressure will subsequently decrease as the pores of the filter become unblocked. Accordingly, the controller may monitor for the initial maximum pressure and then terminate the back-pulse of water through the filter once the pressure drops to a given level, indicating that the particles have been removed from the filter as required.

The system preferably includes a water feed tank configured to store unfiltered water for supply to the filter for the filtering operation. Such an arrangement may be beneficial if the supply of water from the source of water is variable in order to ensure that whenever there is sufficient sunlight, the filter system may operate. Preferably, the system is arranged such that water that passes through the filter during a back-pulse is passed back into the water feed tank. Accordingly, water is not wasted.

Furthermore, the system may be arranged to include an overflow tank into which water from the water feed tank may pass if, during a back-pulse, the water level in the water feed tank exceeds a predetermined level. In addition to preventing the wastage of water, such an arrangement may beneficially remove some of the particles from the water feed tank, enabling the dilution of the water in the water feed tank in order to avoid the filter becoming blocked rapidly after the re-commencement of the filtering operation. The water in the overflow tank may be reserved for uses other than human consumption.

The controller of the system may include a memory that stores data corresponding to the operation of the system. The controller may further be provided with an output unit to enable the output of the data stored in the memory to a data reading device. Such an arrangement may enable the analysis of the operation of the system which may provide useful information for developing further filtration systems, may be useful for scheduling maintenance and/or replacement of part of all of the filtration system and/or may be used for fault finding if there is a problem with the operation of the system.

The present invention will now be described by way of non-limiting examples with reference to the accompanying drawings in which:

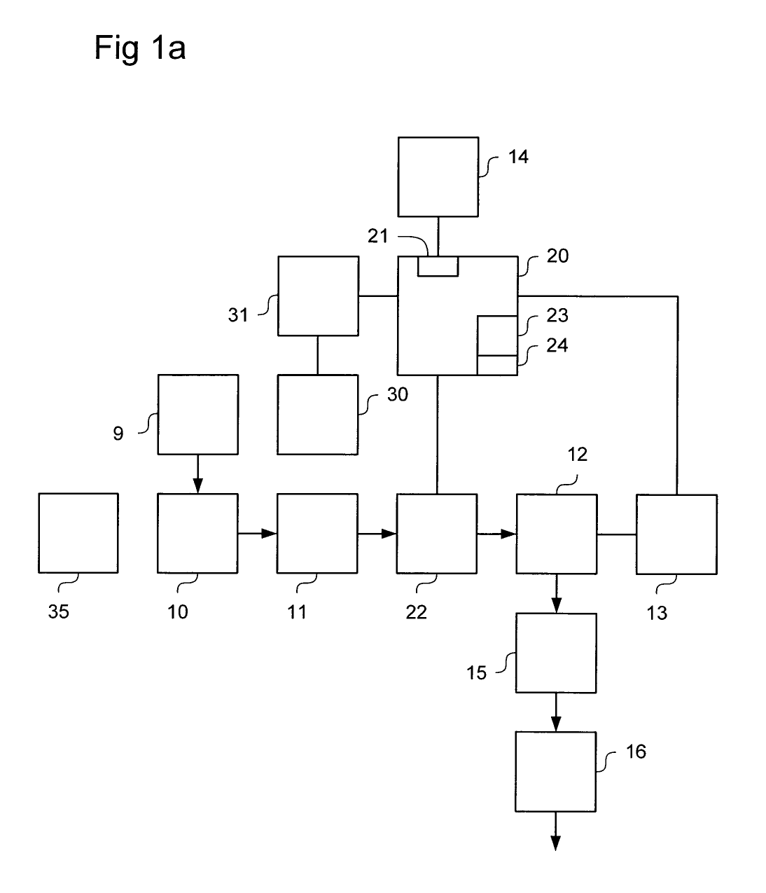

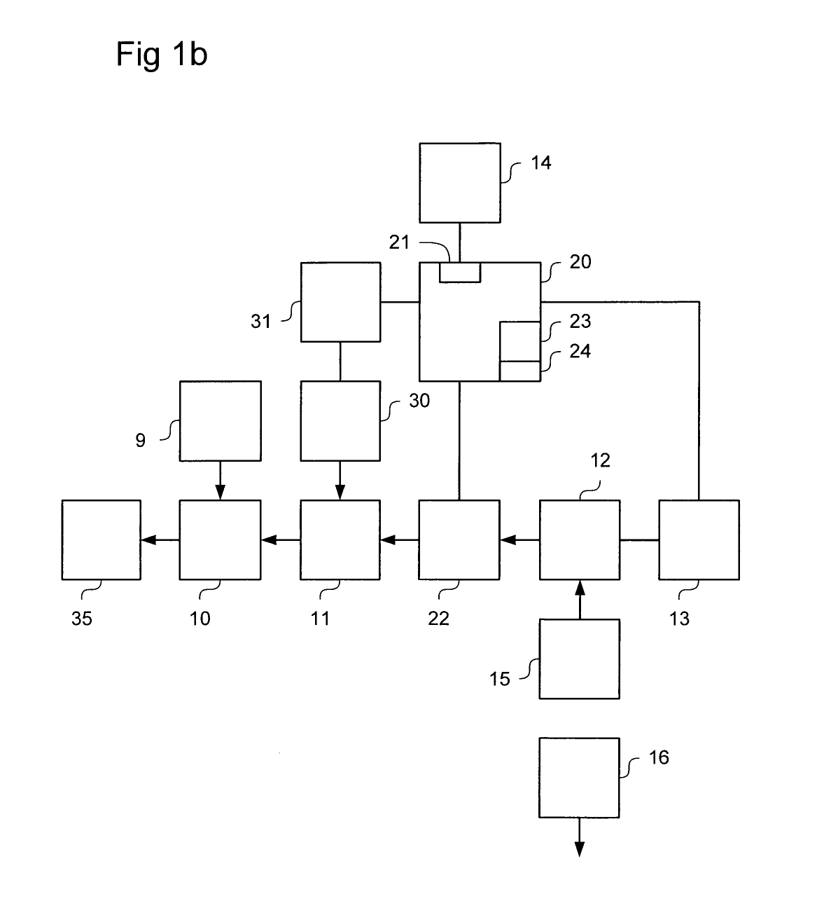

FIG. 1a depicts a water filtration system according to the present invention during a filtering operation;

FIG. 1b depicts a water filtration system according to the present invention during a back-pulse operation;

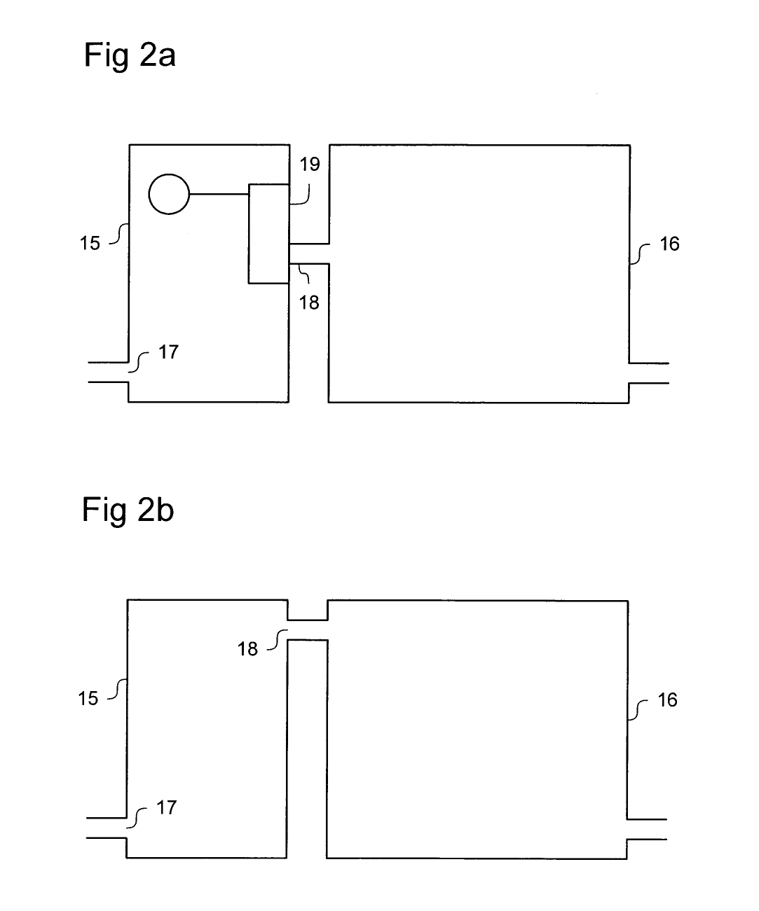

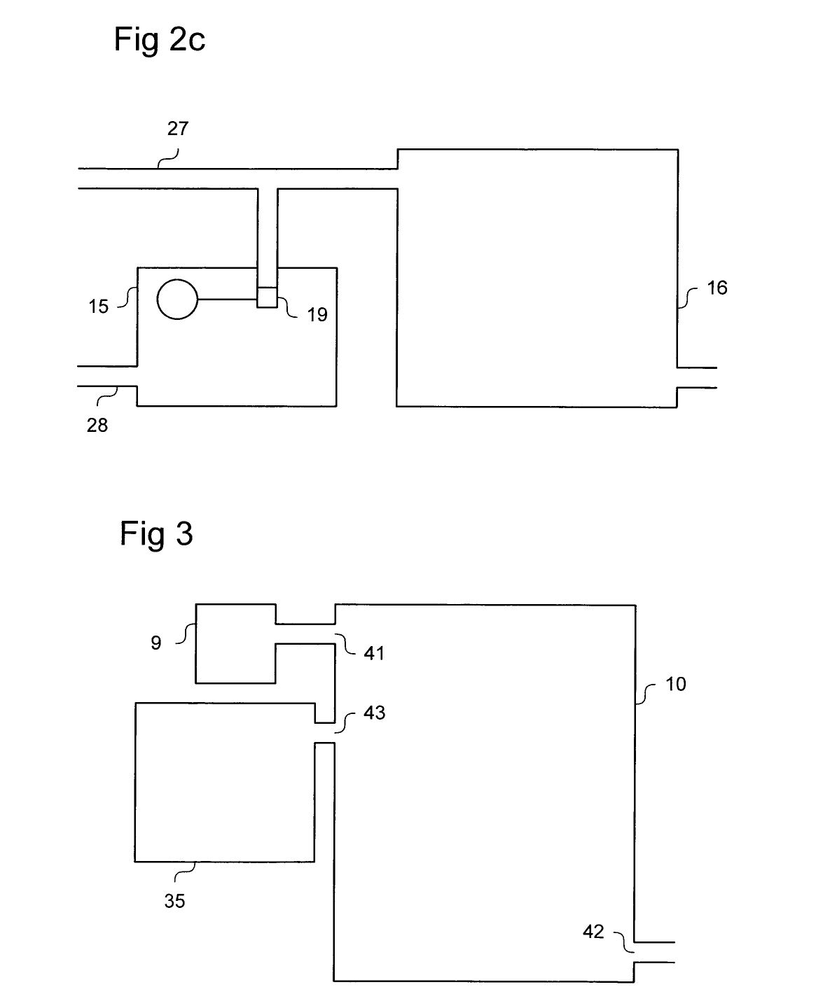

FIGS. 2a, 2b and 2c depict possible arrangements of a back-pulse water storage tank for use with the present invention; and

FIG. 3 depicts an arrangement of a water feed tank for use with the present invention.

As shown in FIG. 1a, the water filtration system according to the present invention may include a water feed tank 10 that is supplied with water from a source 9. Water from the water feed tank 10 is passed through a filter 11 under the action of a pump 12 which is driven by a motor 13. Solar panels 14 are provided in order to provide the power for the operation of the motor 13. Water that has been filtered by the filter 11 is passed initially to a back-pulse water storage tank 15 and, when the back-pulse water storage tank has filled to a given level, filtered water is used to fill a discharge water tank 16. Accordingly, users of the water filtration system may obtain water from the discharge water tank 16 at any time, regardless of whether or not the filtration system is performing a filtering operation as depicted in FIG. 1a. In particular, water may be obtained while a back-pulse operation is being performed at described below or when neither operation is being performed, for example when there is not sufficient sunlight to power the motor 13.

The filter 11 is selected to remove particulates from the water as required. For example, the filter may be a filter that is configured to remove micro-organisms from the water, such as bacteria, viruses, fungi and parasites. In a particular embodiment, the filter is such that particles greater than 1×10⁻⁷ m in size are removed from the water. However, it should be appreciated, that any convenient filter that is suitable for the purpose of the filtering system may be used.

Preferably the pump is a positive displacement pump, such as a helical rotor pump, for example having a rotating metal rotor in a rubber stator. Accordingly, the pump can provide a consistent pressure for forcing water through the filter 11, regardless of the pump speed, namely regardless of the amount of sunlight received by the one or more solar panels 14 that power the motor 13. It will be appreciated, however, that the flow rate of water through the filter 11 will be dependent on the amount of power supplied to motor 13.

The pump 12 is configured such that it may be operated in either direction. Accordingly, in a filtering operation as shown in FIG. 1a, the pump 12 forced water in a forward direction through the filter 11, namely from an unfiltered water side of the water filter 11 to a filtered water side of the filter 11. The pump 12 may also force water in the reverse direction, namely through the filter 11 from the filtered water side of the filter 11 to the unfiltered water side, as described below in further detail with reference to FIG. 1b.

The motor 13 is preferably directly connected to the pump 12 and configured such that the motor 13 may be driven in either direction under the operation of a controller 20. Accordingly, by driving the motor 13 in one direction, the pump 12 forces water through the filter 11 in the forward direction and, by driving the motor 13 in the opposite direction, the pump 12 drives water through the filter 11 in the reverse direction. Such an arrangement requires neither a complicated valve arrangement to control the direction of the flow of water nor a complicated drive mechanism between the motor 13 and the pump 12. Accordingly, the overall system is simplified and made more reliable.

The motor 13 may, in particular, be a high efficiency brushless DC motor. The controller 20 may be any suitable control system but may in particular contain a micro-controller containing the software necessary to control the filter system. It should be appreciated however, that the controller may comprise an integrated circuit device that is hardwired to provide the necessary control logic.

The solar panels 14 that provide power to the system may, in particular, be comprised of photovoltaic cells that provide a DC current. Such cells vary in the efficiency at which they operate, depending on their loading. Accordingly, the controller 20 may include a maximum power point tracker (MMPT) unit 21 that is arranged to optimise the loading of the photovoltaic cells in order to maximise the power extracted from them.

As discussed above, the controller 20 is configured to control the direction of operation of the motor 13 and, in particular is arranged such that the motor may operate in a first direction to drive the pump 12 such that water is driven through the filter 11 in the forward direction, as depicted in FIG. 1a or may control the motor 13 to operate in the opposite direction such that the pump 12 drives water through the filter 11 in the reverse direction, as depicted in FIG. 1b. The ability to reverse the flow of water through the filter 11 provides the capability to clean the filter. In particular, by reversing the flow of water through the filter 11, it is possible to remove particulates from the pores of the filter 11 that may block the filter 11 during use.

The accumulation of particles blocking the pores in the filter 11 during use gradually degrades the performance of the filter. In particular, as the pores become blocked, the amount of power required to drive a given volume of water through the filter increases. Accordingly, the efficiency of the filter system is reduced. Therefore, by periodically reversing the flow of water through the filter it is possible to maintain the efficiency of the filter. Furthermore, if the pressure increases too much, it may cause damage to at least one of the filter 11, the pump 12 and the motor 13. Such back-pulses of water may be manually triggered. However, it is preferable for the back-pulses to be automatically triggered in order to avoid any reliance on correct use by the users. Furthermore, by automatically triggering the back-pulses of water, it is possible to arrange the system such that back-pulses are provided when necessary but only when necessary. Accordingly, unnecessary back-pulses of water are prevented and excessive blocking of the filter, which may result in blockages which cannot be easily removed, may be prevented.

Accordingly, the present invention provides a pressure sensor 22 that measures the pressure of the water in the filtration system. The controller 20 monitors pressure measured by the pressure sensor 22 and triggers the back-pulse automatically based on the pressure measurements. In the arrangement depicted in FIGS. 1a and 1b the pressure sensor 22 is provided between the pump 12 and the filter 11. As a filtering operation proceeds and the filter 11 gradually becomes blocked, the pressure measured by the pressure sensor 22 drops (and the pressure difference across the filter increases). Accordingly, the controller 20 may be configured to trigger a back-pulse of water through the filter 11 when the pressure measured by the pressure sensor 22 drops below a predetermined level. The pressure sensor 22 may, for example, be a pressure transducer. However, other pressure sensing means may also be used.

As depicted in FIG. 1b, during a back-pulse, the pump 12 drives the water from the back-pulse water storage tank 15 through the filter 11 into the water feed tank 10. At the same time, an air blower 30 provides a flow of air to the filter 11, creating bubbles of air that agitate the particles blocking the pores of the filter 11, assisting in removing those particles from the filter. For example, an air feed line may be provided directly underneath the filter so that the bubbles can flow through it. It will be appreciated that the power provided by the solar panels 14 at any given instant may not be sufficient to power both the motor 13 and the air blower 30. Accordingly, the system may include a battery 31 that powers the air blower 30 during back-pulses. During normal filtering operation, however, the motor 13 is preferably driven directly by the solar panels 14 (under the control of the controller 20). The battery 31 may be re-charged using power from the solar panels 14 that is not required to drive the motor 13.

The duration of the back-pulse of water through the filter 11 should be sufficient to unblock particles from the pores of the filter 11, preferably substantially entirely but at least sufficiently that the filtration system can operate efficiently. For simplicity, the controller 20 may include a timer and the back-pulse may be operated to occur for a given period of time that is previously determined to provide a sufficient improvement in the condition of the filter 11. Alternatively or additionally, the controller may be arranged to monitor the water level in the back-pulse water storage tank 15 and may stop the operation of the back-pulse if the water in the back-pulse water storage tank 15 drops to a certain level. In such an arrangement, the back-pulse operation may provide a particular volume of water to flow through the filter 11 in the reverse direction, namely the capacity of the back-pulse water storage tank between the level at which water is directed to the discharge water tank 16 and the level at which the back-pulse operation is terminated. Alternatively or additionally, the controller 20 may terminate the back-pulse operation when it determines that the filter 11 is sufficiently clear of blockages. This determination may be made from monitoring the pressure measured by the pressure sensor 22. In particular, as a back-pulse operation starts, the pressure measured by the pressure sensor 22 may increase to a maximum, corresponding to the back pressure generated by the filter when particles are blocking the pores of the filter 11. Thereafter, as particles are removed from the pores and the filter becomes less blocked, the measured pressure will decrease and the controller 20 may terminate the back-pulse when the pressure subsequently drops to a given level, indicating that the filter 11 is sufficiently unblocked.

It should be appreciated that the controller 20 may utilise any combination of the back-pulse termination controls discussed above. For example, even if the controller is configured to control the back-pulse once the filter is sufficiently unblocked, namely based on the pressure measurements, it may be beneficial for the controller 20 to terminate the back-pulse if the water level in the back-pulse water storage tank 15 drops below a given level, namely to stop the back-pulse if there is not sufficient water in the back-pulse water storage tank to completely unblock the filter 11.

As discussed above, the system is configured such that the back-pulse water storage tank 15 is preferentially filled before the discharge water tank 16 is filled in order to ensure that a supply of water is maintained for back-pulse operation. A valve may be provided to direct water either to the back-pulse water storage tank 15 or to the discharge water tank 16, depending on whether or not sufficient water is stored in the back-pulse water storage tank 15. However, in order to avoid the requirement for such a valve system that responds to the water level in the back-pulse water storage tank 15, the system may, as depicted in FIGS. 1a and 1b, be arranged such that all water is directed into the back-pulse water storage tank 15 and thereafter into the discharge water tank 16, provided that sufficient water is stored within the back-pulse water storage tank 15. Such a system may be more reliable because there are fewer components that potentially may go wrong. Furthermore, such an arrangement avoids water being stored and stationary in the back-pulse water storage tank 15 for a prolonged period of time.

FIGS. 2a, 2b and 2c depict alternative arrangements for a back-pulse water storage tank 15 and a discharge water tank 16 according to the present invention. As shown in FIG. 2a, in a first arrangement, water is passed into and out of the back-pulse water storage tank 15 from and to the pump 12 through a first opening 17. A second opening 18 is provided to pass water from the back-pulse water storage tank 15 to the discharge water tank 16. A float-valve 19 is provided to permit water to flow from the back-pulse water storage tank 15 into the discharge water tank 16 when the water level in the back-pulse water storage tank reaches a sufficient level for the float-valve 19 to open. Alternatively, as depicted in FIG. 2b, the back-pulse water storage tank 15 may simply be configured such that once the water level in the back-pulse water storage tank 15 is sufficiently high the water may flow through the second opening 18 into the discharge water tank 16. Alternatively, as depicted in FIG. 2c, a feed pipe 27 is provided directly from the pump 12 to the discharge water tank 16 but a float valve 19 is provided to divert water from the feed pipe 27 to the back-pulse water storage tank 15. A separate feed pipe 28 may be provided to supply the water from the back-pulse water storage tank 15 for use in back-pulse operation.

As depicted in FIGS. 1a and 1b, an overflow tank 35 may be provided into which water from the water feed tank 10 may flow during a back-pulse operation if the water level in the water feed tank 10 exceeds a given level. The overflow may allow particulates removed from the filter 11 to be removed from the water feed tank 10, diluting the particulates in the water feed tank 10 such that, when filtering operation resumes, the filter 11 does not rapidly become blocked. The water in the overflow tank 35 may be reserved for uses other than for drinking water, for example for irrigation.

FIG. 3 depicts schematically a possible arrangement of a water feed tank having such an overflow tank 35. In particular, water from a water source 9 is fed into the water feed tank 10 through a first opening 41 and passes from the water feed tank 10 to the filter 11 through a second opening 42. If, during a back-pulse operation the water level in the water feed tank 10 reaches a certain level, water flows through a third opening 43 in the water feed tank 10 into the overflow tank 35.

The controller 20 may include a memory 23 that stores information about the operation of the filter system. An output 24 may be provided for outputting the data. The output may be any suitable data output means, for example a connection to the memory 23, providing a physical connection to be made between the memory 23 and a data reading device, enabling the data to be downloaded to the device. Alternatively, the output 24 may, for example, provide a wireless connection to a data collection device, either providing a short-range wireless connection to a data collection device, avoiding the need to provide an opening into the controller 20 which may make the system less reliable or, if appropriate, a connection via satellite such that the data can be collected periodically without physically visiting the system. The latter arrangement may be especially beneficial if the filtration system is to be used in remote locations.

The data stored may be any data that is useful. For example the data may include the number of times that the controller 20 has performed a back-pulse operation, the frequency of the back-pulse operations and/or the date and/or time of the back-pulse operations. Alternatively or additionally, the data may relate to the total time that one or more of the components has been in operation, for example the total time of operation of the motor 13 and/or pump 12, the total time of operation of the air blower 30 and/or the total time in service of a particular filter. Alternatively or additionally the data may provide a complete record of the operation of the filtration system.

The data recorded by the controller 20 may be used for a variety of reasons. For example, the data may be used to schedule maintenance of part or all of the filtration system. Alternatively or additionally, the data may be used to schedule replacement of part or all of the filtration system, for example the filter and/or pump and/or the motor and/or the air blower may be replaced after a given number of hours of operation in order to ensure reliability. Alternatively or additionally, the data may be used to monitor the effectiveness and efficiency of the filtration system which may assist in designing subsequent generations of filtration systems. Alternatively or additionally, the data may be used for fault finding.

1. A water filtration system, comprising:
a filter;
a pump for forcing water through the filter; and
at least one solar panel, configured to power the pump;
wherein the pump is configured such that it may be operated in either direction such that the pump may force water through the filter in either a forward direction in order to pass water from an unfiltered water side to a filtered water side or in a reverse direction in order to pass water from a filtered water side to an unfiltered water side; and
the water filtration system further comprises:
a pressure sensor, configured to measure the water pressure on the filtered water side of the filter; and
a controller, configured to control the operation of the pump such that, in filtering operation, water is forced through the filter in the forward direction and, when the water pressure on the filtered water side of the filter drops below a predetermined level, water is forced through the filter in the reverse direction.

2. A water filtration system according to claim 1, further comprising an air blower, configured such that, when the pump is operated to force water through the filter in the reverse direction, the air blower provides a supply of air bubbles that pass through the filter.

3. A water filtration system according to claim 2, further comprising a battery, configured to be re-charged by power from said at least one solar panel;
wherein the air blower is powered by the battery.

4. A water filtration system according to claim 1, wherein the pump is a positive displacement pump.

5. A water filtration system according to claim 1, wherein the pump is driven by a motor that is directly powered by said at least one solar panel;
wherein said motor is configured such that the controller can set the motor to operate in either a forward direction or a reverse direction such that, by controlling the direction of operation of the motor, the controller can control the direction of operation of the pump.

6. A water filtration system according to claim 1, wherein the filter is configured to remove particles from the water that are larger than 1×10⁻⁷ m in size and pass smaller particles.

7. A water filtration system according to any claim 1, wherein the pump is provided at the filtered water side of the filter; and the pressure sensor measures the water pressure between the filter and the pump.

8. A water filtration system according to claim 1, wherein said at least one solar panel comprises at least one photovoltaic cell;
and the controller includes a maximum power point tracking unit that is configured to optimise the loading of said at least one photovoltaic cell in order to maximise the power extracted from said at least one photovoltaic cell.

9. A water filtration system according to claim 1, further comprising a discharge water tank into which the filtered water may be passed for storage prior to use.

10. A water filtration system according to claim 9, further comprising a back-pulse water storage tank;
wherein the water filtration system is configured such that, during filtering operation, filtered water is passed into the back-pulse water storage tank until the back-pulse water storage tank is filled to a predetermined level, after which the filtered water is passed to the discharge water tank; and, when the controller controls the pump to force water through the filter in the reverse direction, water is drawn from the back-pulse water storage tank to pass through the filter.

11. A water filtration system according to claim 10, wherein during operation of the pump to force water through the filter in the reverse direction, if the level in the back-pulse water storage tank drops to a second predetermined level, the controller stops operating the pump in the reverse direction.

12. A water filtration system according to claim 1, wherein during operation of the pump to force water through the filter in the reverse direction, if a predetermined amount of time has elapsed while pumping in the reverse direction, the controller stops operating the pump in the reverse direction.

13. A water filtration system according to claim 1, wherein during operation of the pump to force water through the filter in the reverse direction, if the pressure measured by the pressure sensor, having increased to a maximum pressure subsequently drops below a second predetermined level, the controller stops operating the pump in the reverse direction.

14. A water filtration system according to claim 1, further comprising a water feed tank configured to store unfiltered water and supply water to the filter;
wherein, when the controller operates the pump to pass water through the filter in the reverse direction, water is passed back into the water feed tank.

15. A water filtration system according to claim 14, further comprising an overflow tank; wherein the water feed tank is configured such that if, when the controller operates the pump to pass water through the filter in the reverse direction, the water level in the water feed tank exceeds a predetermined level, water is passed from the water feed tank to the overflow tank.

16. A water filtration system according to claim 1, wherein the controller comprises a memory, configured to store data corresponding to the operation of the water filtration system; and an output configured to output the data stored in the memory.

17. A water filtration method, comprising:
using a pump, that is configured such that it may be operated in either direction, to force water through a filter in a forward direction in order to pass water from an unfiltered water side to a filtered water side;
powering the pump using at least one solar panel;
measuring the water pressure on the filtered water side of the filter using a pressure sensor; and
controlling the operation of the pump such that, when the water pressure on the filtered water side of the filter drops below a predetermined level, the pump is used to force water through the filter in a reverse direction from a filtered water side to an unfiltered water side.

18. A water filtration method according to claim 17, further comprising using an air blower to provide a supply of air bubbles that pass through the filter when the pump is operated to force water through the filter in the reverse direction.

19. A water filtration method according to claim 18, further comprising:
powering the air blower by a battery; and
re-charging the battery using power from said at least one solar panel.

20. A water filtration method according to claim 17, wherein said at least one solar panel comprises at least one photovoltaic cell;
and the method comprises using a maximum power point tracking unit to optimise the loading of said at least one photovoltaic cell in order to maximise the power extracted from said at least one photovoltaic cell.

21. A water filtration method according to claim 17, further comprising passing the filtered water into a discharge water tank for storage prior to use.

22. A water filtration method according to claim 21, wherein during filtering operation, filtered water is passed to a back-pulse water storage tank until the back-pulse water storage tank is filled to a predetermined level, after which the filtered water is passed to the discharge water tank; and, when water is forced through the filter in the reverse direction, water is drawn from the back-pulse water storage tank to pass through the filter.

23. A water filtration method according to claim 22, wherein, when water is forced through the filter in the reverse direction, if the level in the back-pulse water storage tank drops to a second predetermined level, the operation of the pump in the reverse direction is stopped.

24. A water filtration method according to claim 17, wherein, when water is forced through the filter in the reverse direction, if a predetermined amount of time has elapsed while pumping in the reverse direction, the operation of the pump is stopped.

25. A water filtration method according to claim 17, wherein, when water is forced through the filter in the reverse direction, if the pressure measured by the pressure sensor, having increased to a maximum pressure subsequently drops below a second predetermined level, operation of the pump in the reverse direction is stopped.

26. A water filtration method according to claim 17, wherein, unfiltered water is supplied from a water feed tank to the filter during filtering operation; and
when water is forced through the filter in the reverse direction, water is passed back into the water feed tank.

27. A water filtration method according to claim 26 wherein, if, when water is forced through the filter in the reverse direction, the water level in the water feed tank exceeds a predetermined level, water is passed from the water feed tank to an overflow tank.

28. A water filtration method according to claim 17, further comprising storing data corresponding to the operation of the water filtration system in a memory.
